(19) United States
(12) Patent Application Publication
(10) Pub. No.: US 2026/0134576 A1
(43) Pub. Date: May 14, 2026

(54) EFFICIENT GAUSSIAN SPLATTING COMPRESSION METHOD

(71) Applicant: InterDigital VC Holdings, Inc., Wilmington, DE (US)

(72) Inventors: Yuning Huang, West Lafayette, IN (US); Jiahao Pang, Plainsboro, NJ (US); Dong Tian, Boxborough, MA (US)

(21) Appl. No.: 18/942,127

(22) Filed: Nov. 8, 2024

(51) Int. Cl. G06T 9/00

(52) U.S. Cl. CPC G06T 9/001

(57) ABSTRACT

Some embodiments of a method may include: estimating distribution statistics for a 3D Gaussian Splatting model corresponding to one or more 3D Gaussian Splatting parameters, wherein the distribution statistics comprise a distribution model; performing quantization of the one or more 3D Gaussian Splatting parameters; and encoding the quantized one or more 3D Gaussian Splatting parameters based on the estimated distribution statistics.

### INCORPORATION BY REFERENCE

The present application incorporates by reference in their entirety the following applications: U.S. Non-Provisional patent application Ser. No. 18/923,318, entitled “DYNAMIC GAUSSIAN SPLATTING LEARNED FROM HIERARCHICAL MOTION MODEL” and filed Oct. 22, 2024 (“318 application”).

### BACKGROUND

The present application is related to 3D reconstruction and rendering.

### SUMMARY

A first example method in accordance with some embodiments may include: estimating distribution statistics for a 3D Gaussian Splatting model corresponding to one or more 3D Gaussian Splatting parameters, wherein the distribution statistics include a distribution model; performing quantization of the one or more 3D Gaussian Splatting parameters; and encoding the quantized one or more 3D Gaussian Splatting parameters based on the estimated distribution statistics.

Some embodiments of the first example method may further include determining the one or more 3D Gaussian Splatting parameters are spherical harmonic AC coefficients, wherein the distribution model is a Laplace distribution.

Some embodiments of the first example method may further include determining the one or more 3D Gaussian Splatting parameters are opacity parameters, wherein the distribution model is a Poisson distribution.

Some embodiments of the first example method may further include performing pruning of the 3D Gaussian Splatting model, wherein the 3D Gaussian Splatting model includes two or more Gaussians.

For some embodiments of the first example method, pruning of the 3D Gaussian Splatting model includes: assigning an importance level to each of the two or more Gaussians; and eliminating, from the 3D Gaussian Splatting model, one or more of the two or more Gaussians with a corresponding importance level below a threshold.

For some embodiments of the first example method, pruning of the 3D Gaussian Splatting model includes: determining a mean-based value for each of the two or more Gaussians; and eliminating, from the 3D Gaussian Splatting model, one or more of the two or more Gaussians with a corresponding mean-based value outside a set range.

Some embodiments of the first example method may further include using rate control to adjust a percentage of pruning of the 3D Gaussian Splatting model.

Some embodiments of the first example method may further include performing finetuning of the 3D Gaussian Splatting model.

For some embodiments of the first example method, finetuning of the 3D Gaussian Splatting model includes performing one of a parameter clip process, a normalization process, and a resetting process on the 3D Gaussian Splatting model.

Some embodiments of the first example method may further include using rate control to adjust a percentage of finetuning of the 3D Gaussian Splatting model.

Some embodiments of the first example method may further include encoding one or more of the estimated distribution statistics.

Some embodiments of the first example method may further include: performing a GS optimization; and performing an adaptive loss computation,

For some embodiments of the first example method, performing the GS optimization includes performing a joint optimization of GS reconstruction quality and compressed bitstream size.

A first example apparatus in accordance with some embodiments may include: a processor; and a memory storing instructions operative, when executed by the processor, to cause the apparatus to: estimate distribution statistics for a 3D Gaussian Splatting model corresponding to one or more 3D Gaussian Splatting parameters, wherein the distribution statistics include a distribution model; perform quantization of the one or more 3D Gaussian Splatting parameters; and encode the quantized one or more 3D Gaussian Splatting parameters based on the estimated distribution statistics.

A second example method/apparatus in accordance with some embodiments may include: obtaining estimated distribution statistics for a 3D Gaussian Splatting model, wherein the distribution statistics include a distribution model; decoding one or more quantized 3D Gaussian Splatting parameters based on the estimated distribution statistics, wherein the one or more quantized 3D Gaussian Splatting parameters correspond to the 3D Gaussian Splatting model; and dequantizing the one or more quantized 3D Gaussian Splatting parameters to generate the 3D Gaussian Splatting parameters.

For some embodiments of the second example method, obtaining the estimated distribution statistics includes decoding one or more of the estimated distribution statistics.

Some embodiments of the second example method may further include determining the one or more 3D Gaussian Splatting parameters are spherical harmonic AC coefficients, wherein the distribution model is a Laplace distribution.

Some embodiments of the second example method may further include determining the one or more 3D Gaussian Splatting parameters are opacity parameters, wherein the distribution model is a Poisson distribution.

Some embodiments of the second example method may further include determining the one or more 3D Gaussian Splatting parameters are one of: spherical harmonic DC coefficients, geometry parameters, shape parameters, and DC coefficients of color, wherein the distribution model is a Gaussian distribution.

For some embodiments of the second example method, obtaining the estimated distribution statistics includes using one or more pre-determined and fixed parameters.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a process diagram illustrating an example process for creating a 3D Gaussian Splatting according to some embodiments.

FIG. 3 is a set of graphs illustrating example histograms of spherical harmonic AC coefficients according to some embodiments.

FIG. 4 is a process diagram illustrating an example Gaussian Splatting encoder according to some embodiments.

FIG. 5 is a process diagram illustrating an example Gaussian Splatting decoder according to some embodiments.

FIG. 6 is a process diagram illustrating an example input Gaussian Splatting model according to some embodiments.

FIG. 7 is a process diagram illustrating an example Gaussian Splatting entropy encoder according to some embodiments.

FIG. 8 is a process diagram illustrating an example Gaussian Splatting entropy decoder according to some embodiments.

FIG. 9 is a process diagram illustrating an example joint 3DGS construction and entropy encoding optimization process according to some embodiments.

FIG. 10 is a flowchart illustrating an example encoding process according to some embodiments.

FIG. 11 is a flowchart illustrating an example decoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

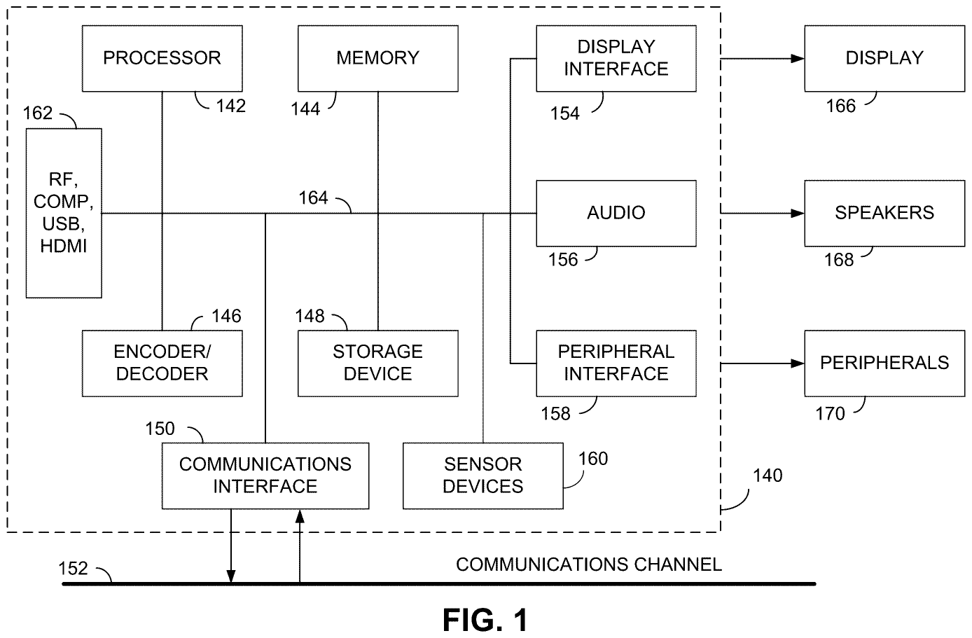

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

This application belongs to the field of 3D reconstruction and rendering and targets 3D Gaussian Splatting related techniques. This field aims to develop tools for compression, analysis, interpolation, representation and understanding of 3D Gaussian Splatting.

### Problem Statement

### View Synthesis in Immersive Application

For immersive applications, many view synthesis technologies display novel views. Many depth image-based rendering (DIBR) technologies use depth maps to synthesize novel views based on captured views using hand-crafted algorithms. The traditional synthesis DIBR approaches often suffer with artifacts due to occlusions between viewing positions.

With recent developments in artificial intelligence, Neural Radiance Fields (NeRF) have been proved to be a remarkable method to synthesize new views of a complex scene from a limited number of captured views. During the last three years, a lot of progress has been made since the method was first presented in Mildenhall, Ben, et al., Nerf: Representing Scenes as Neural Radiance Fields for View Synthesis, 65:1 COMMS OF THE ACM 99-106 (2021) (“Mildenhall”).

NeRF may be viewed as an implicit representation of a 3D scene. NeRF uses a neural network with filled parameters to represent a 3D scene. The neural parameters are obtained through a training procedure. In particular, the neural network is intentionally “overfitted” to a particular 3D object or scene. In this way, NeRF demonstrates much better render quality than traditional DIBR approaches. The improved rendering quality of NeRF should credit to a fact that neural network may better “predict” occluded areas than handcrafted hole filling methods with traditional DIBR. Unfortunately, computational complexity remains a hinderance since NeRF aims to evaluate the scene luminance for all points of the 3D volume.

### 3D Gaussian Splatting

3D Gaussian Splatting is an emerging technology with a potential to overcome the computation complexity with NeRF while maintaining a high quality of view synthesis. It may efficiently represent and render 3D scenes.

In the seminal work of Kerbl, Bernhard, et al., 3D Gaussian Splatting for Real-Time Radiance Field Rendering, 42:2 ACM TRANS. GRAPH. 139-1 (2023) (“Kerbl”), 3D Gaussian Splatting was shown a fast-rendering speed as point-based rendering techniques, while suppressing many coinciding artifacts. 3D Gaussian Splatting utilizes 3D Gaussian as the primitive to represent the geometry and texture of a 3D scene. Specifically, 3D Gaussian Splatting models a scene as a set of 3D Gaussians, which are defined by their means, covariances, opacity and spherical harmonics that model their view dependent color, including RGB values.

### 3G Gaussian Splatting and Point Clouds

3D Gaussian Splatting format may be viewed as a new type of point cloud data. The arithmetic means of Gaussians are point positions, and each point is associated with a new list of attributes. The covariance (as new types of point cloud attributes) together with point positions provide a complete description of surfaces. This is in contrast to naïve point clouds, in which the points are discrete samples on a surface, which is an incomplete representation of a surface. In addition to the three RGB values, opacity and spherical harmonics (and point cloud attributes) significantly enhance the rendering quality.

### 3D Gaussian Splatting and NeRF

While 3D Gaussian Splatting (3DGS) shares the same projection modeling motivation as neural radiance field (NeRF) rendering methods, 3D Gaussian Splatting may avoid the need to densely sample points over the rays that project to a novel view. Instead, the 3D Gaussians are projected directly onto the image plane as 2D splats. This methodology avoids unnecessary computation in an empty space, which reduces training time and achieves real-time rendering. Moreover, by utilizing a differentiable projection and rasterization step, the Gaussian parameters may be optimized with supervision in the 2D domain than in the 3D domain. For example, optimization may be done by minimizing the photometric loss between a rendered image and a ground truth view captured from the scene.

During optimization of the Gaussian parameters, Kerbl designed a highly-efficient tile-based rasterizer that allows for alpha-blending of anisotropic splats while respecting the order of the Gaussians in the 3D space. Given a set of images and camera positions, the 3D representation of a scene may be fitted in a few minutes and rendered as novel views in real time. This speed, along with the explicit nature of the Gaussian primitive that allows for straight-forward geometry manipulation, has made 3D Gaussian Splatting one of the commonly used differential rendering techniques in a large range of applications.

The main drawback of 3DGS is that 3DGS requires a large amount of memory for the storage of the Gaussians. Kerb/reports a memory consumption significantly higher than NeRF-based methods, which becomes a hurdle for the deployment of 3DGS in consumer devices or low-end GPUs. They generate many Gaussians due to a densification process during optimization (cloning and splitting). Furthermore, there are many attributes characterizing each Gaussian. These aspects complicate the transmission and manipulation of 3DGS.

### Problem Solved

3D Gaussian Splatting (3DGS) was proposed as a view synthesis technology suitable for rendering objects or scenes. Though 3DGS has been shown superiority in its rendering quality and speed, 3DGS continues to have a problem with the high memory required to generate, store, and/or transmit many 3D Gaussians. This problem arises from the creation of 3D Gaussians, in which rendering quality is the only optimization target. To address this problem, this application presents a compression scheme, which enables an efficient 3D Gaussian compression.

### Description of Application

This application discusses a compression scheme for 3D Gaussian Splatting. Motivated by finding a statistical distribution that 3D Gaussian Splatting parameters follow, a compression scheme may be used to code 3D Gaussian Splatting models. The AC coefficients of spherical harmonic coefficients follow a Laplace distribution. The compression is further enhanced by preprocessing for pruning and finetuning.

### Related Techniques

As a complete geometry representation, 3D Gaussians are not only composed of point position (x, y, z) but also shapes (covariances of the Gaussians). The additional covariance enables a complete representation of the geometry by filling up the “holes” between sampled points. Regarding color, 3D Gaussian is composed of opacity and spherical harmonic coefficients that may be used to represent color from multiple viewpoints.

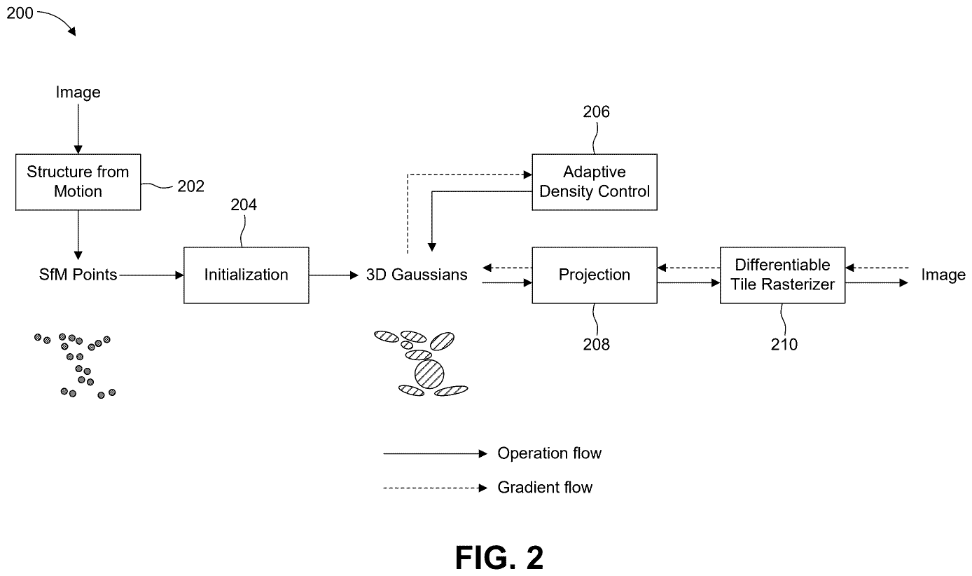

FIG. 2 is a process diagram illustrating an example process for creating a 3D Gaussian Splatting according to some embodiments. FIG. 2 illustrates a high-level pipeline of how 3D Gaussian Splatting works, starting with images that are captured for an object or a scene. The images may be a sequence of monocular pictures with a moving camera or a sequence of multiview pictures for some embodiments.

For an example process 200, image(s) are inputted into an SfM (Structure from Motion) block 202 to create the depth information based on the input images, which are converted to 3D points, known as SfM points. An example SfM block may use a COLMAP algorithm, according to Schonberger, Johannes L. and Frahm, Jan-Michael, Structure-from-Motion Revisited, IN PROC. OF IEEE CONF. ON COMP. VISION AND PATTERN RECOGNITION 4104-4113 (2016) (“Schonberger”).

An initialization process 204 initializes the SfM points as a set of 3D Gaussians. Each 3D Gaussian includes both geometry information and color information. The position and color coefficient are inherited directly from the SfM block 202, and the covariance matrix is initialized as an isotropic Gaussian with axes equal to the mean of the distance to the closest three points.

A projection block 208 projects the position of each 3D Gaussian onto an image plane from a camera's perspectives by applying an affine transformation. After the geometry relationship between 3D points and pixels is established via projection, pixel colors are computed.

Rasterization 210 computes pixel color values based on the 3D Gaussian attributes. According to the geometry relationship identified in the projection step, the Gaussians are sorted according to depth with Gaussians first that are closer to the camera. For each pixel, an iterative blending process is performed over the sorted Gaussian to render the final color.

An Adaptive Density Control (ADC) block 206 aims to grow or prune Gaussian primitives. The growth of Gaussian is done via cloning or splitting of existing Gaussians based on their shape and volume. Gaussians with opacity less than a predetermined (hard) threshold are removed or pruned.

A backward propagation is required in order to refine the initial 3D Gaussian. Backward propagation is a process similar to training a neural network model. An error is first computed by comparing rasterization results against the ground truth image. Such a methodology implies that the camera viewpoints from ground truth images are chosen to do the projection/rasterization. Based on the pixel-wise error, the associated gradients are computed. These gradients show the direction and magnitude by which the Gaussian parameters are to be updated to minimize the error. The Gaussians are updated by subtracting the gradients scaled by a learning rate.

After presenting how 3D Gaussian Splatting works, this application discusses a brief overview of how to deal with the high memory requirements.

Fan, Zhiwen, et al., LightGaussian: Unbounded 3D Gaussian Compression with 15× Reduction and 200+ FPS, arXiv preprint arXiv: 2311.17245 (2023) (“Fan”) presented LightGaussian, a method designed to transform 3D Gaussians into a more efficient and compact format. Inspired by the concept of network pruning, LightGaussian empirically identifies Gaussians that are insignificant in contributing to the scene reconstruction and adopts a pruning and recovery process. This work is understood to be limited by the handcrafted manner to reduce the size of 3D Gaussians as well as noticeable extra training time.

Niedermayr, Simon, et al., Compressed 3D Gaussian Splatting for Accelerated Novel View Synthesis, IN PROC. OF IEEE/CVF CONF. ON COMP. VISION AND PATTERN RECOGNITION 10349-10358 (2024) (“Niedermayr”) proposed a compressed 3D Gaussian Splatting representation that utilizes sensitivity-aware vector clustering with quantization-aware training to compress directional colors and Gaussian parameters. Niedermayr is understood to require the Gaussian model to be finetuned for each rate point to avoid a significant quality drop.

### Motivations

Various Gaussian parameters exert different levels of influence on the visual quality of rendered images. The Gaussian positions have the greatest impact on rendering quality. They typically exhibit an irregular sampling. The shape of the Gaussians may also play a second significant role, particularly in terms of the rotation parameter. Gaussian opacity is a parameter that remains robust against variations due to the application of activation functions, like a sigmoid function. Additionally, spherical harmonic coefficients for view-dependent color may be categorized into DC and AC components. Both DC and AC components demonstrate resilience to variations, with the AC component being especially more robust. Based on the sensitivity of different types of parameters, a type-specific method is discussed for an efficient compression with a better balance between rate and visual quality.

Each type of Gaussian parameter shows its specific statistical characteristics. They are grouped accordingly for compression purposes. The position parameters have a large dynamic range and appear not to obey a standard distribution. Most of the remaining parameters approximately follow Gaussian distributions. Interestingly, the opacity parameter follows more of a Poisson distribution, and the AC parameters in spherical harmonics comply with Laplace distributions over different datasets.

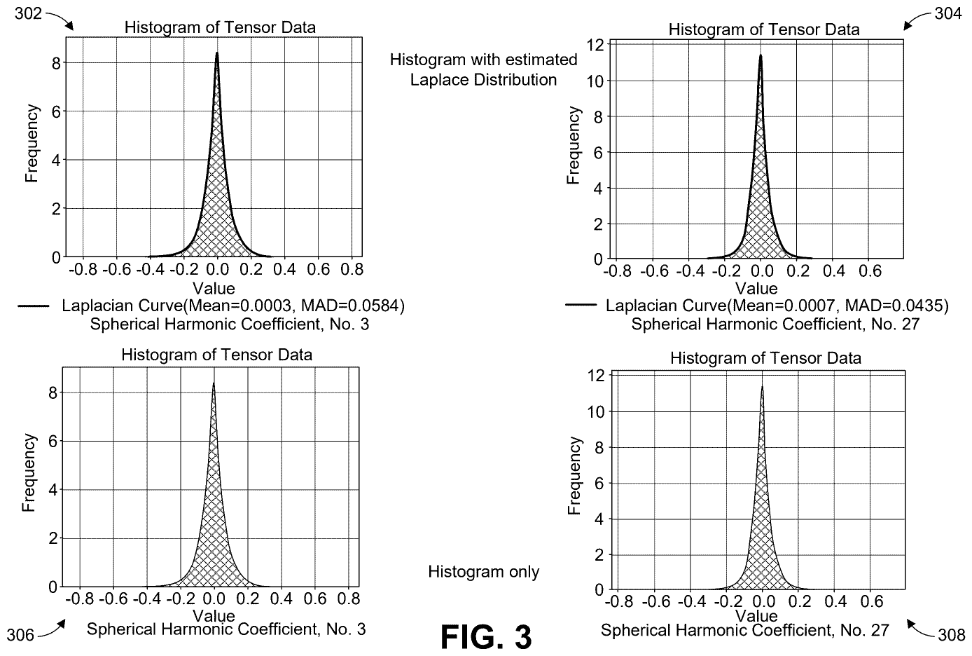

FIG. 3 is a set of graphs illustrating example histograms of spherical harmonic AC coefficients according to some embodiments. FIG. 3 shows example histograms 306, 308 by themselves and histograms 302, 304 with estimated Laplace distributions from the “Bicycle” set of the “MipNeRF” dataset.

The observation that many 3D Gaussian parameters obey certain mathematic distribution was not discovered in any literature work to the best of our knowledge. These findings enable an efficient entropy coding method for 3D Gaussian Splatting. Coding methods for 3D Gaussian Splatting parameters may be based on certain mathematic distribution models, in which a Poisson distribution is assumed for opacity and a Laplace distribution is used for AC components of spherical harmonic coefficients. For some embodiments, other distribution models may be used to code the 3DGS parameters.

### Gaussian Splatting Compression

### Encoding

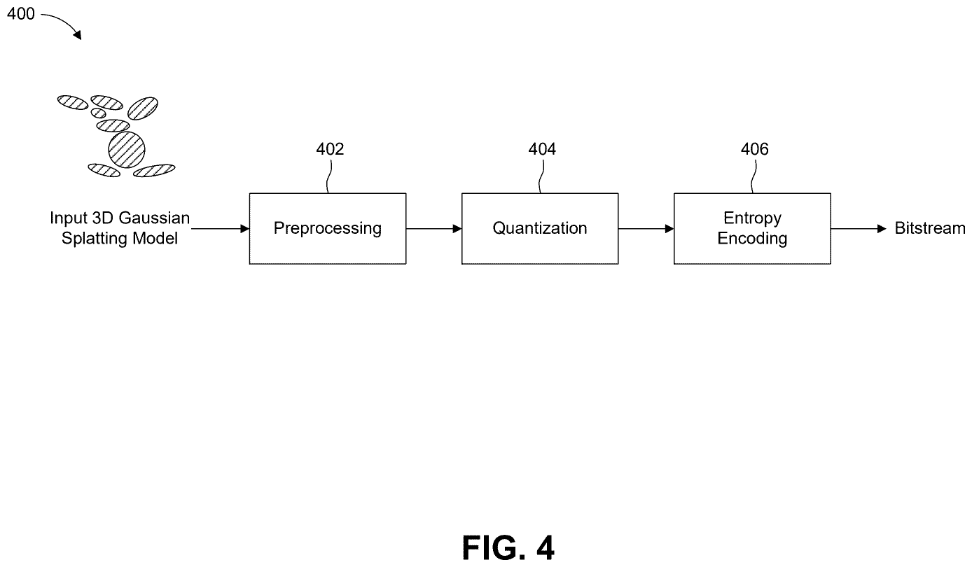

FIG. 4 is a process diagram illustrating an example Gaussian Splatting encoder according to some embodiments. Given an input 3D Gaussian Splatting model, FIG. 4 shows an example encoding process 400. In a preprocessing step 402, the input 3D Gaussian models are pruned and finetuned as they are typical noisy or there are quite many outliers. The goal of the preprocessing is to improve the model to favor the next compression task while having a minimum impact on the rendering quality. Quantization 404 is conducted on the improved 3D Gaussian Splatting models. The quantized 3D Gaussian models are entropy encoded. The entropy encoding 406 is based on the distribution types described earlier. When lossy compression on the 3D Gaussian model is concerned, a rate-control mechanism may be achieved by setting the percentage of pruning (preprocessing) and quantization.

### Decoding

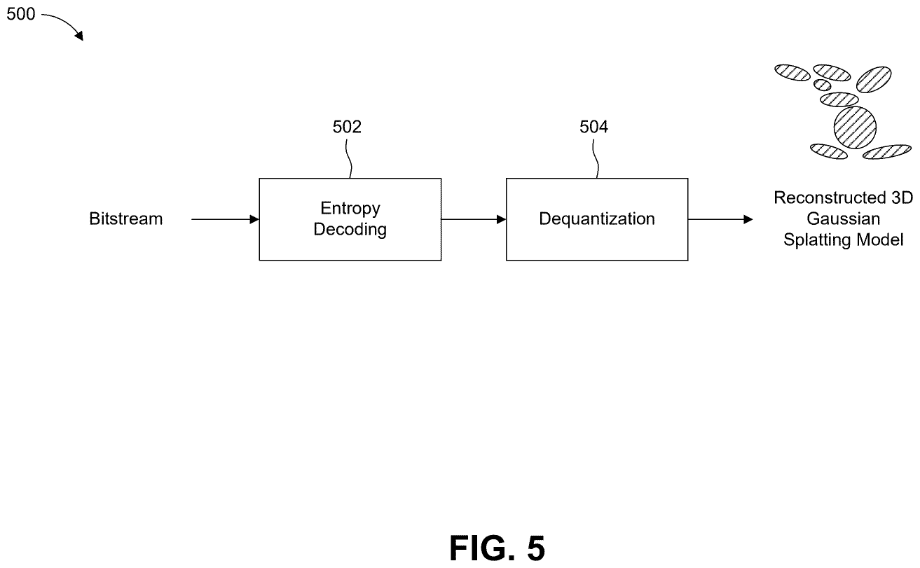

FIG. 5 is a process diagram illustrating an example Gaussian Splatting decoder according to some embodiments. FIG. 5 shows an example decoder 500 for the 3D Gaussian Splatting models. The example decoder 500 is composed of two steps: entropy decoding 502 and dequantization 504. The entropy decoding 502 is also based on the novel findings upon the same types of distribution as described earlier. After entropy decoding 502, dequantization 504 is performed to reconstruct the original 3D Gaussian Splatting models.

### Preprocessing

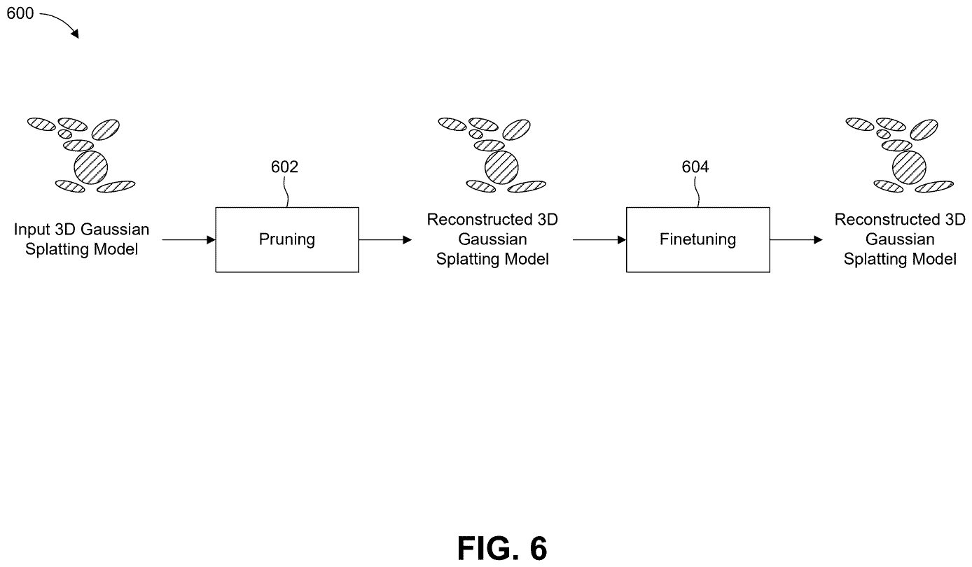

FIG. 6 is a process diagram illustrating an example input Gaussian Splatting model according to some embodiments. In some embodiments, an example preprocessing process 600 is composed of two steps: pruning 602 and finetuning 604, as shown in FIG. 6 and described below.

### Pruning

By pruning, Gaussians that are either less important or assumed as outliers are removed. A cleaner Gaussian model is expected, and the Gaussian parameters will better follow a statistical distribution. In the end, the Gaussians are more “friendly” for compression purposes.

The pruning procedure bears two steps with specific criteria. A first criteria sets pruning based on the importance level. A second criteria sets pruning based on the statistical behavior of each Gaussian.

In the importance-based pruning step, the importance level is calculated based on a few factors. Gaussians with smaller opacity (o) are treated as less important because they are more transparent. The term Iₒ is used to represent importance based on opacity. Gaussians with larger volume (v) are assigned a greater importance. The term Iᵥ is used to represent importance based on volume. The number of image pixels (n) affected by a Gaussian also indicates a different importance. The term Iₚ is used to represent the importance based on the number of pixels. In some embodiments, the three factors are combined to determine the importance level, e.g., by a product of individual importances as shown in Eq. 1:

$$Importance Level = {I}_{o} \times {I}_{v} \times {I}_{p} \qquad ( 1 )$$

Statistic-based pruning deletes Gaussians if they are too difficult to encode. Statistical behavior is determined by comparing the value of each group of Gaussian parameters with an estimated standard distribution. In some embodiments, if the mean value is not within the range shown in Eq. 2, the Gaussian is pruned:

$$Range = [ mean - 3 \times standard\_deviation , mean + 3 \times standard\_deviation ] \qquad ( 2 )$$

The percentage of pruned Gaussians has a direct impact on rendering quality. The percentage selected is a balance between the compression ratio and rendering quality.

### Finetuning

The finetuning stage aims to compensate for the rendering quality loss introduced by the previous pruning step. The finetuning stage may improve the statistical behavior of certain types of Gaussian parameters. The finetuning is a modified version of the original training procedure of Gaussian Splattings. In some embodiments, the finetuning uses at least one of the additional techniques: parameter clip, normalization, and resetting.

Specifically, a parameter clip may be done for opacity before an activation function according to Eq. 3:

$$v = max ( min ( v , max\_value ) , min\_value ) \qquad ( 3 )$$

where v is the Gaussian parameter, the max_value and min_value are the value range. In some embodiments, for opacity, max_value is set to 5, and min_value is set to −5. The parameter clip helps address the training saturation problem.

In some embodiments, the parameter clip on geometry is set according to Eqs. 4 and 5:

$$max\_value = mean + 3 \times standard\_deviation \qquad ( 4 )$$

$$min\_value = mean - 3 \times standard\_deviation \qquad ( 5 )$$

Normalization may be used to scale the AC components according to a predetermined range, such as the ranges shown in Eq. 6:

$$Range = [ mean - 3 \times standard\_deviation , mean + 3 \times standard\_deviation ] \qquad ( 6 )$$

This methodology lets the AC components follow a distribution with a smaller standard deviation. In some embodiments, outlier values may be reset to 0.

In some embodiments, the parameter clip, normalization, and/or resets are done periodically instead of one-time only. Fine-tuning may be able to compensate for the quality loss introduced by pruning, even when the pruning is rather aggressive, e.g., pruning up to 60% of the Gaussians. Light pruning and finetuning may even enhance rendering quality due to the high noise and redundancy in an original 3D Gaussian Splatting.

### Quantization and Entropy Coding

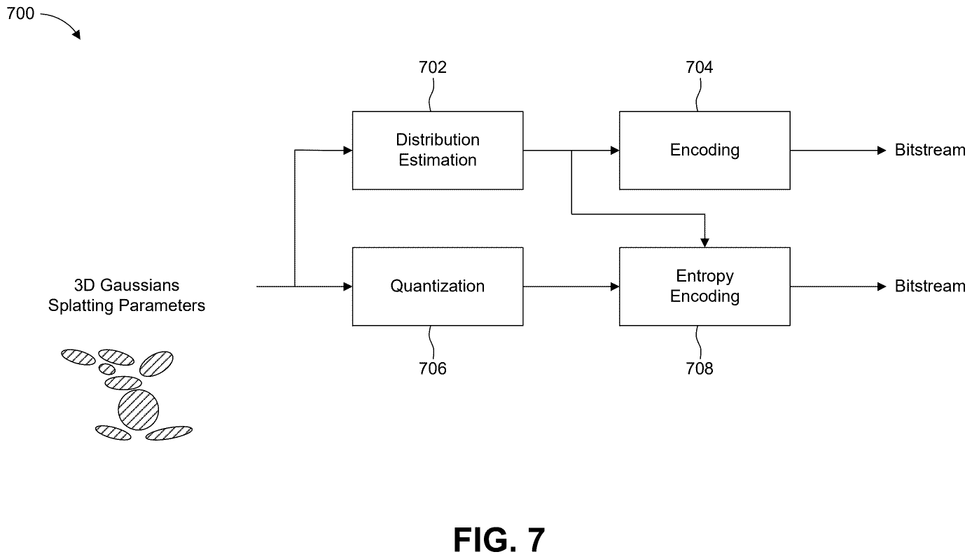

FIG. 7 is a process diagram illustrating an example Gaussian Splatting entropy encoder according to some embodiments. After input 3D Gaussian Splatting models are preprocessed, entropy coding may be done based on statistical characteristics data. FIG. 7 shows an example process 700 for performing Gaussian Splatting encoding.

An example set of Gaussian parameters may be classified into five groups according to the analysis discussed previously: (1) Geometry with 3 channels; (2) Shape with 7 channels, including both rotation with 4 channels and scaling with 3 channels; (3) Opacity with 1 channel; (4) DC coefficients of color with 3 channels; and (5) AC coefficients of color with 45 channels.

Each group of parameters is quantized 706 using a different quantization step based on their sensitivity and impact on rendering quality. Statistical entropy coding 708 is applied to the data using a predetermined distribution type and estimated statistics. The predetermined distribution type and estimated statistics are obtained by a distribution estimation process 702. A standard distribution is not used for geometry information (x, y, z). Instead, an existing point cloud geometry codec is used to encode them. For shape, opacity, and DC coefficients of color, a Gaussian is used to model their distributions. For the AC coefficients, a Laplace distribution is used to model their distributions. The encoding 704 of each type of parameter follows the diagram in FIG. 7.

The 3D Gaussian Splatting parameters are supplied as inputs to the encoding process 700. During preprocessing, the input parameters are sent to a distribution estimation process 702 to compute the distribution parameters. This estimation assumes a Gaussian distribution model if the inputs are for shape, opacity and DC coefficients of color. For Gaussian distributions, the distribution parameters are mean u and standard deviation σ. A Laplace distribution model is assumed if the inputs are AC coefficients. For Laplace distributions, the distribution parameters are location parameter μ and scale parameter b. In some embodiments, the estimated distribution parameters are encoded into a bitstream if the distribution estimation process 702 is conducted on the fly to update the distribution parameters. In some embodiments, the distribution parameter is fixed and supplied as part of the encoder parameters, in which no specific coding on the distribution parameter is required. With a dynamically updated distribution parameter, a higher coding efficiency may be expected, but more computation may be needed for encoding.

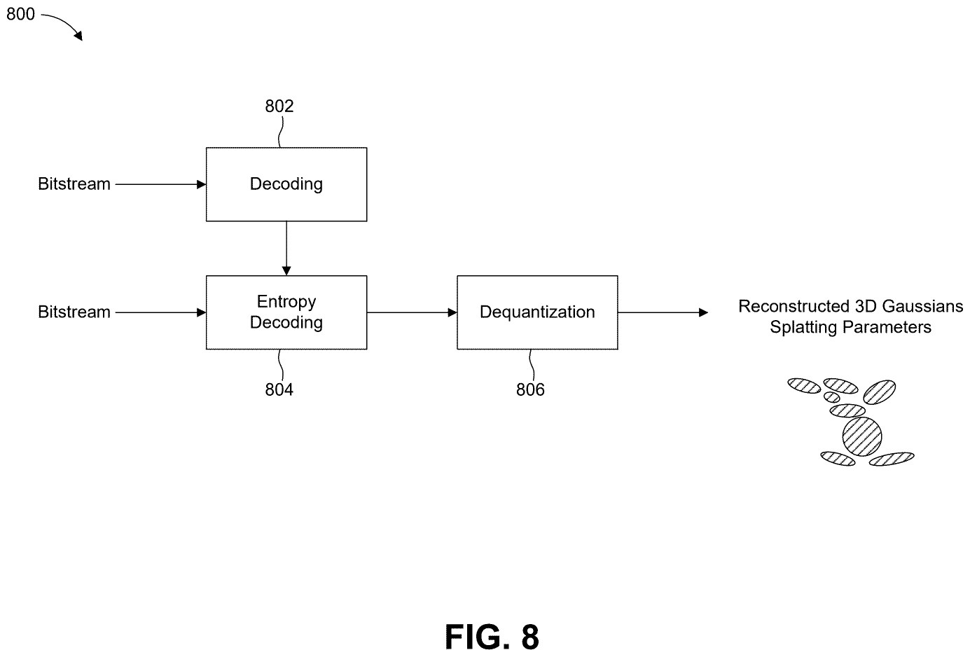

FIG. 8 is a process diagram illustrating an example Gaussian Splatting entropy decoder according to some embodiments. The corresponding decoding of each type of parameter is depicted in the example Gaussian Splatting entropy decoder 800 of FIG. 8. In some embodiments, the decoding process 802 receives a bitstream representing the distribution model parameters. The decoding process 802 may be signaled which type of parameter is received via a third way. The decoding process 802 sets the distribution model using the decoded distribution model parameters. In some embodiments, the distribution parameters are not decoded but assumed to be pre-selected as part of the decoder. When the decoder 802 receives the bitstream for coded 3D Gaussian Splatting parameters, the distribution model helps with the entropy decoding 804. After entropy decoding 804, a dequantization 806 is performed to reconstruct the 3D Gaussian Splatting parameters to their original range.

### Joint 3DGS Construction and Entropy Coding Optimization

For some embodiments, the entropy coding and the 3DGS construction process may be performed jointly, so that the constructed 3DGS is more favorable for entropy coding and may result in a smaller bitstream.

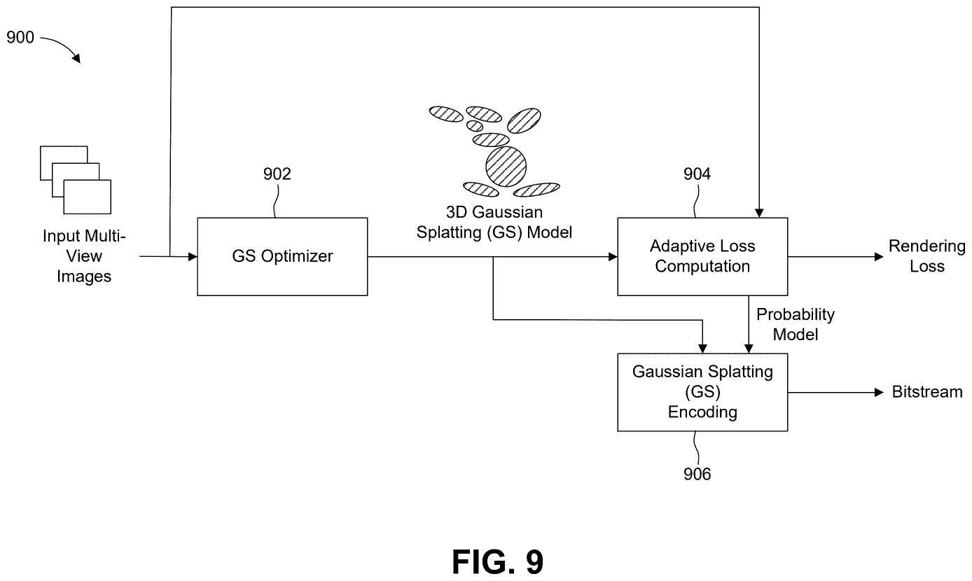

FIG. 9 is a process diagram illustrating an example joint 3DGS construction and entropy encoding optimization process according to some embodiments. FIG. 9 shows an example process 900 with one optimization iteration of the GS. Given the input multi-view images, the GS optimizer block 902 outputs a GS model. In some embodiments, the optimizer block 902 is the optimization process in Kerbl. The GS model is inputted into an adaptive loss computation block 904 and a Gaussian Splatting (GS) encoding block 906. The adaptive loss computation block 904 has a set of loss functions for computing rendering loss, in which each loss function corresponds to a distribution model for the GS parameters. For example, applying an L1 loss function corresponds to assuming the GS parameters follow a Laplace distribution, while applying an L2 loss function corresponds to assuming the GS parameters follow a Gaussian distribution.

The GS Encoder 906 tentatively encodes the GS model with the distribution model assumed in the adaptive loss computation model and outputs a bitstream. The overall loss function to be optimized is given by Eq. 7:

$$loss\_function = rendering\_loss + ( λ \cdot bitstream\_size ) \qquad ( 7 )$$

where λ0 is the tradeoff parameter between rate and the distortion. By iteratively applying the optimization process defined in Eq. 7, the output GS model becomes more favorable for compression with the output distribution model. For some embodiments, the GS encoding block 906 may be the same entropy encoding block 406 shown in FIG. 4.

### Rate Control

For some embodiments, rate control may be used. In some embodiments, only the quantization step size is in use for rate control. It may be preferred for its simplicity as it has no additional training or finetuning. This method may be more limited due to limited RD performance.

In some embodiments, the pruning percentage may be changed dynamically in addition to selection of a quantization step. This methodology may yield a better RD performance, while requiring additional computation for a customized pruning percentage and finetuning for each rate point.

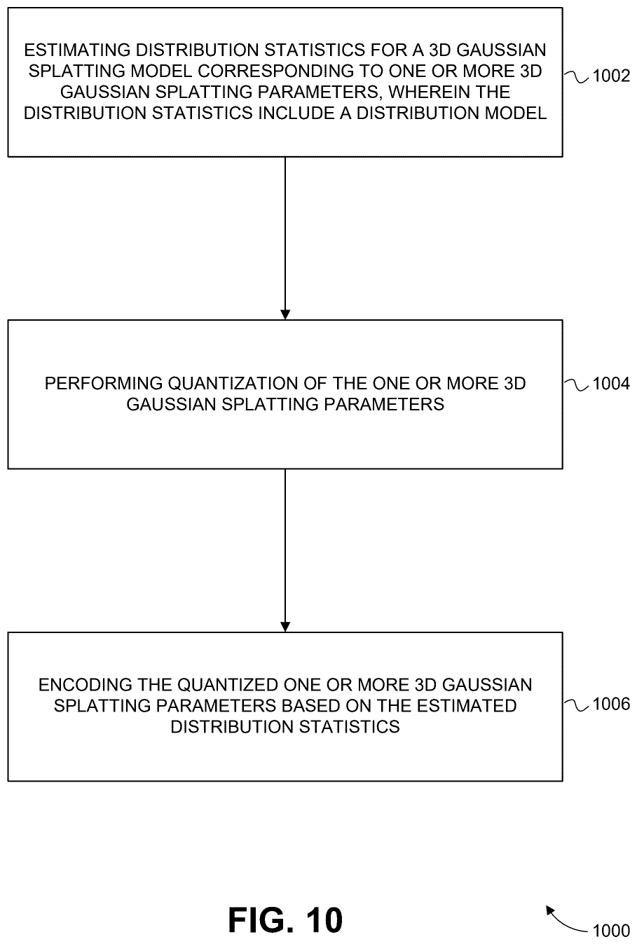

FIG. 10 is a flowchart illustrating an example encoding process according to some embodiments. For some embodiments, an example process 1000 may include estimating 1002 distribution statistics for a 3D Gaussian Splatting model corresponding to one or more 3D Gaussian Splatting parameters, wherein the distribution statistics include a distribution model. For some embodiments, the example process 1000 may further include performing 1004 quantization of the one or more 3D Gaussian Splatting parameters. For some embodiments, the example process 1000 may further include encoding 1006 the quantized one or more 3D Gaussian Splatting parameters based on the estimated distribution statistics.

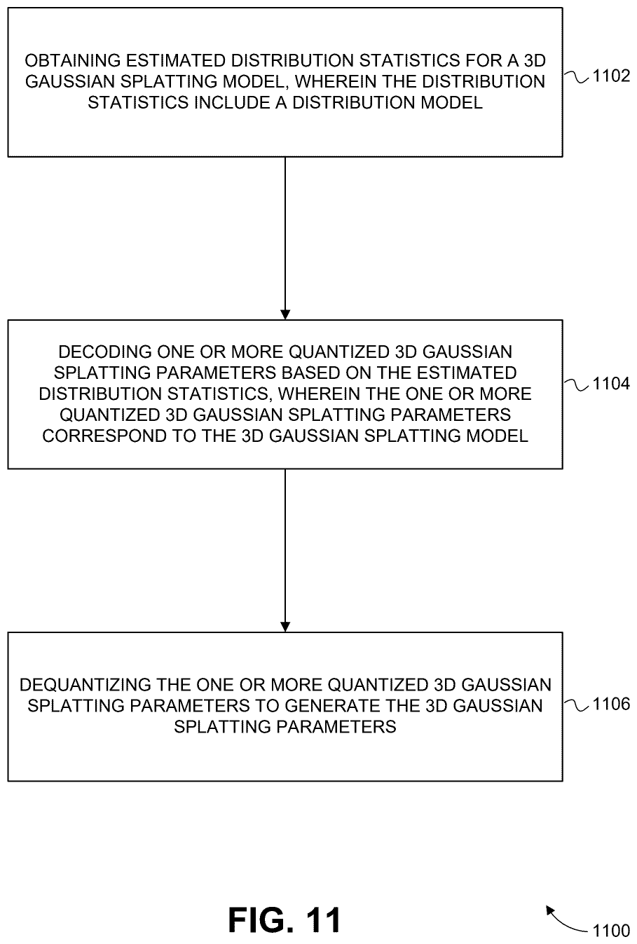

FIG. 11 is a flowchart illustrating an example decoding process according to some embodiments. For some embodiments, an example process 1100 may include obtaining 1102 estimated distribution statistics for a 3D Gaussian Splatting model, wherein the distribution statistics include a distribution model. For some embodiments, the example process 1100 may further include decoding 1104 one or more quantized 3D Gaussian Splatting parameters based on the estimated distribution statistics, wherein the one or more quantized 3D Gaussian Splatting parameters correspond to the 3D Gaussian Splatting model. For some embodiments, the example process 1100 may further include dequantizing 1106 the one or more quantized 3D Gaussian Splatting parameters to generate the 3D Gaussian Splatting parameters.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: estimating distribution statistics for a 3D Gaussian Splatting model corresponding to one or more 3D Gaussian Splatting parameters, wherein the distribution statistics include a distribution model; performing quantization of the one or more 3D Gaussian Splatting parameters; and encoding the quantized one or more 3D Gaussian Splatting parameters based on the estimated distribution statistics.

Some embodiments of the first example method may further include determining the one or more 3D Gaussian Splatting parameters are spherical harmonic AC coefficients, wherein the distribution model is a Laplace distribution.

Some embodiments of the first example method may further include determining the one or more 3D Gaussian Splatting parameters are opacity parameters, wherein the distribution model is a Poisson distribution.

Some embodiments of the first example method may further include performing pruning of the 3D Gaussian Splatting model, wherein the 3D Gaussian Splatting model includes two or more Gaussians.

For some embodiments of the first example method, pruning of the 3D Gaussian Splatting model includes: assigning an importance level to each of the two or more Gaussians; and eliminating, from the 3D Gaussian Splatting model, one or more of the two or more Gaussians with a corresponding importance level below a threshold.

For some embodiments of the first example method, pruning of the 3D Gaussian Splatting model includes: determining a mean-based value for each of the two or more Gaussians; and eliminating, from the 3D Gaussian Splatting model, one or more of the two or more Gaussians with a corresponding mean-based value outside a set range.

Some embodiments of the first example method may further include using rate control to adjust a percentage of pruning of the 3D Gaussian Splatting model.

Some embodiments of the first example method may further include performing finetuning of the 3D Gaussian Splatting model.

For some embodiments of the first example method, finetuning of the 3D Gaussian Splatting model includes performing one of a parameter clip process, a normalization process, and a resetting process on the 3D Gaussian Splatting model.

Some embodiments of the first example method may further include using rate control to adjust a percentage of finetuning of the 3D Gaussian Splatting model.

Some embodiments of the first example method may further include encoding one or more of the estimated distribution statistics.

Some embodiments of the first example method may further include: performing a GS optimization; and performing an adaptive loss computation,

For some embodiments of the first example method, performing the GS optimization includes performing a joint optimization of GS reconstruction quality and compressed bitstream size.

A first example apparatus in accordance with some embodiments may include: a processor; and a memory storing instructions operative, when executed by the processor, to cause the apparatus to: estimate distribution statistics for a 3D Gaussian Splatting model corresponding to one or more 3D Gaussian Splatting parameters, wherein the distribution statistics include a distribution model; perform quantization of the one or more 3D Gaussian Splatting parameters; and encode the quantized one or more 3D Gaussian Splatting parameters based on the estimated distribution statistics.

A second example method/apparatus in accordance with some embodiments may include: obtaining estimated distribution statistics for a 3D Gaussian Splatting model, wherein the distribution statistics include a distribution model; decoding one or more quantized 3D Gaussian Splatting parameters based on the estimated distribution statistics, wherein the one or more quantized 3D Gaussian Splatting parameters correspond to the 3D Gaussian Splatting model; and dequantizing the one or more quantized 3D Gaussian Splatting parameters to generate the 3D Gaussian Splatting parameters.

For some embodiments of the second example method, obtaining the estimated distribution statistics includes decoding one or more of the estimated distribution statistics.

Some embodiments of the second example method may further include determining the one or more 3D Gaussian Splatting parameters are spherical harmonic AC coefficients, wherein the distribution model is a Laplace distribution.

Some embodiments of the second example method may further include determining the one or more 3D Gaussian Splatting parameters are opacity parameters, wherein the distribution model is a Poisson distribution.

Some embodiments of the second example method may further include determining the one or more 3D Gaussian Splatting parameters are one of: spherical harmonic DC coefficients, geometry parameters, shape parameters, and DC coefficients of color, wherein the distribution model is a Gaussian distribution.

For some embodiments of the second example method, obtaining the estimated distribution statistics includes using one or more pre-determined and fixed parameters.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
estimating distribution statistics for a 3D Gaussian Splatting model corresponding to one or more 3D Gaussian Splatting parameters,
wherein the distribution statistics comprise a distribution model;
performing quantization of the one or more 3D Gaussian Splatting parameters; and
encoding the quantized one or more 3D Gaussian Splatting parameters based on the estimated distribution statistics.

2. The method of claim 1, further comprising:
determining the one or more 3D Gaussian Splatting parameters are spherical harmonic AC coefficients,
wherein the distribution model is a Laplace distribution.

3. The method of claim 1, further comprising:
determining the one or more 3D Gaussian Splatting parameters are opacity parameters,
wherein the distribution model is a Poisson distribution.

4. The method of claim 1, further comprising:
performing pruning of the 3D Gaussian Splatting model,
wherein the 3D Gaussian Splatting model comprises two or more Gaussians.

5. The method of claim 4, wherein pruning of the 3D Gaussian Splatting model comprises:
assigning an importance level to each of the two or more Gaussians; and
eliminating, from the 3D Gaussian Splatting model, one or more of the two or more Gaussians with a corresponding importance level below a threshold.

6. The method of claim 4, wherein pruning of the 3D Gaussian Splatting model comprises:
determining a mean-based value for each of the two or more Gaussians; and
eliminating, from the 3D Gaussian Splatting model, one or more of the two or more Gaussians with a corresponding mean-based value outside a set range.

7. The method of claim 4, further comprising using rate control to adjust a percentage of pruning of the 3D Gaussian Splatting model.

8. The method of claim 1, further comprising performing finetuning of the 3D Gaussian Splatting model.

9. The method of claim 8, wherein finetuning of the 3D Gaussian Splatting model comprises performing one of a parameter clip process, a normalization process, and a resetting process on the 3D Gaussian Splatting model.

10. The method of claim 8, further comprising using rate control to adjust a percentage of finetuning of the 3D Gaussian Splatting model.

11. The method of claim 1, further comprising encoding one or more of the estimated distribution statistics.

12. The method of claim 1, further comprising:
performing a GS optimization; and
performing an adaptive loss computation.

13. The method of claim 1, wherein performing the GS optimization comprises performing a joint optimization of GS reconstruction quality and compressed bitstream size.

14. An apparatus comprising:
a processor; and
a memory storing instructions operative, when executed by the processor, to cause the apparatus to:
estimate distribution statistics for a 3D Gaussian Splatting model corresponding to one or more 3D Gaussian Splatting parameters,
wherein the distribution statistics comprise a distribution model;
perform quantization of the one or more 3D Gaussian Splatting parameters; and
encode the quantized one or more 3D Gaussian Splatting parameters based on the estimated distribution statistics.

15. A method comprising:
obtaining estimated distribution statistics for a 3D Gaussian Splatting model,
wherein the distribution statistics comprise a distribution model;
decoding one or more quantized 3D Gaussian Splatting parameters based on the estimated distribution statistics,
wherein the one or more quantized 3D Gaussian Splatting parameters correspond to the 3D Gaussian Splatting model; and
dequantizing the one or more quantized 3D Gaussian Splatting parameters to generate the 3D Gaussian Splatting parameters.

16. The method of claim 15, wherein obtaining the estimated distribution statistics comprises decoding one or more of the estimated distribution statistics.

17. The method of claim 15, further comprising:
determining the one or more 3D Gaussian Splatting parameters are spherical harmonic AC coefficients,
wherein the distribution model is a Laplace distribution.

18. The method of claim 15, further comprising:
determining the one or more 3D Gaussian Splatting parameters are opacity parameters,
wherein the distribution model is a Poisson distribution.

19. The method of claim 15, further comprising:
determining the one or more 3D Gaussian Splatting parameters are one of: spherical harmonic DC coefficients, geometry parameters, shape parameters, and DC coefficients of color,
wherein the distribution model is a Gaussian distribution.

20. The method of claim 15, wherein obtaining the estimated distribution statistics comprises using one or more pre-determined and fixed parameters.
